(19) United States
(12) Patent Application Publication
(10) Pub. No.: US 2004/0154816 A1
(43) Pub. Date: Aug. 12, 2004

(54) Modular electrical conduit system

(76) Inventor: John Rainbolt, East Palo Alto, CA (US)

Correspondence Address: PERKINS COIE LLP, P.O. BOX 2168, MENLO PARK, CA, 94026, US

(21) Appl. No.: 10/366,265

(22) Filed: Feb. 12, 2003

(51) Int. Cl. H02G 3/04

(52) U.S. Cl. 174/48

(57) ABSTRACT

A modular conduit system for routing communications lines within the interior of a structure is disclosed. The conduit system comprises a modular housing for containing electrical wiring and other communications cables. In certain embodiments, the modular housing is configured to be installed along an edge of an inner wall covering. The modular housing includes ports for enabling outlets to be connected with the contained electrical wiring. The modular housing also includes a housing cover for enclosing the electrical wiring and communications cables within the housing. The housing cover is removably mounted with the modular housing. The housing cover can be removed in order to enable access to the electrical wiring and communications cables without interfering with or causing damage to the inner wall covering of the wall structure, for example.

### FIELD OF THE INVENTION

The present invention relates to a partially external modular conduit system for use in structures. More specifically, the invention teaches a modular conduit system which greatly saves space while improving the serviceability and upgradability of telecommunications networks and electrical routing.

### BACKGROUND OF INVENTION

The vast majority of new homes and office buildings have telephone and electrical power lines built into their wall structures during construction. Typically wall framing is constructed, then holes are drilled through the beams, and all necessary wiring is installed within the wall frame. Drywall is then installed and all necessary outlets, switches and fixtures are installed in the drywall. Also a baseboard is installed at the base of the wall.

FIG. 1 shows one conventional residential wall section 10. Wall 10 includes a frame structure 12. A typical frame structure 12 is constructed of wooden vertical 2″ by 4″ studs (not shown independently of frame structure 12) positioned roughly 16″ apart upon horizontal baseplate 13. This frame structure is secured to a floor 14 by nails or screws. Upon the vertical studs is mounted horizontal top plate 15. On to the frame structure 12 is attached outer wall 16, which may comprise a number of various materials. Some of the more common materials for outer wall 16 include various siding materials such as overlapping planks, shingles, aluminum siding, vinyl siding and various composite structures.

Within frame structure 12 is installed any wiring and telecommunications lines required for the residence. One or more holes 18 are drilled in the studs making up the frame 12, in order to allow the wiring to pass through the frame 12. Then outlets 22 are attached to frame 12. Outlets 22 generally include power outlets for supplying 110-volt ac current, or telephone jacks. The wiring (not shown) is connected to outlets 22 in order to connect the outlets to appropriate power, or communications networks. Switches 24 are also attached to the frame 12, and are connected with the 110-volt wiring (not shown) in order to enable control of various lights and other devices within the residence.

An inner wall 20 is attached to frame structure 12 by means of nails or screws. The individual panels comprising inner wall 20 are generally referred to as plasterboard, drywall, gypsum board, or sheet rock. Inner wall 20 may also comprise plaster, paneling, or wood planks, etc. The inner wall as a whole may also be referred to as plasterboard, drywall, gypsum board, or sheet rock. Generally holes (not shown) must be cut in the drywall 20 in order to accommodate outlets 22 and switches 24. Baseboard 26 is mounted over drywall 20. Generally drywall 20 is ⅝″ thick, and baseboard 26 is up to ¾″ thick. Finally, inner wall 20 is surfaced to cover up any irregularities and seams, and then textured and painted.

One problem with conventional wall structures is there is no mechanism for accessing the wiring once the wall is completed. Another problem is that there is no mechanism for upgrading an existing home with new telecommunications network technology. Often homeowners wish to add the latest communications and entertainment technology to their homes. Such technology includes home theater sound systems, cable and satellite television systems, computer network systems, additional telephone lines, etc. With conventional homes the lines and cables required for these technologies either had to be laid on the surface of interior portions of the home, or wall and/or floor sections had to be torn open and resealed at great cost.

What is needed is a modular conduit that allows access to the wiring system of a building. Also needed is a modular conduit for containing a building's wiring and communications lines that uses very little space. Additionally needed is a conduit system capable of enabling a building to utilize the newest technology without requiring modification of the building's structure.

### SUMMARY OF THE INVENTION

The present invention provides a modular conduit system that allows access to the wiring system of a building. The modular conduit system is capable of containing a building's wiring and communications lines. Further, the conduit system is capable of enabling a building to utilize the newest technology without requiring modification of the building's structure.

According to certain embodiments, the present invention includes a modular conduit system for routing communications lines within the interior of a structure, such as a wall structure, for example. The conduit system comprises a modular housing for containing electrical wiring and other communications cables. In certain embodiments, the modular housing is configured to be installed along an edge of an inner wall covering. The modular housing includes ports for enabling outlets to be connected with the contained electrical wiring. The modular housing also includes a housing cover for enclosing the electrical wiring and communications cables within the housing. The housing cover is removably mounted with the modular housing. The housing cover can be removed in order to enable access to the electrical wiring and communications cables without interfering with or causing damage to the inner wall covering of the wall structure, for example.

### BRIEF DESCRIPTION OF THE DRAWINGS

FIG. 1 illustrates a conventional residential wall constructed;

FIG. 2 illustrates a wall structure in accordance with one embodiment of the present invention;

FIG. 3 is a perspective view of one embodiment of the modular conduit system of the present invention;

FIG. 4 is a cross-sectional end view of a conduit in accordance with one embodiment of the present invention;

FIG. 5 is a front view of a conduit in accordance with one embodiment of the present invention;

FIG. 6 is a front view of a conduit in accordance with an alternative embodiment of the present invention;

FIG. 7 is a front view of a conduit in accordance with yet another alternative embodiment of the present invention, and

FIG. 8 is a method at 800 for constructing a wall in accordance with one embodiment of the present invention.

### DETAILED DESCRIPTION OF THE PREFERRED EMBODIMENT

According to certain embodiments, the present invention includes a modular conduit system for routing communications lines within the interior of a structure, such as a wall structure, for example. The conduit system comprises a modular housing for containing electrical wiring and other communications cables. In certain embodiments, the modular housing is configured to be installed below a lower edge of an inner wall covering. The modular housing includes ports for enabling outlets to be connected with the contained electrical wiring. The modular housing also includes a housing cover for enclosing the electrical wiring and communications cables within the housing. The housing cover is removably mounted with the modular housing. The housing cover can be removed in order to enable access to the electrical wiring and communications cables without interfering with or causing damage to the inner wall covering of the wall structure, for example.

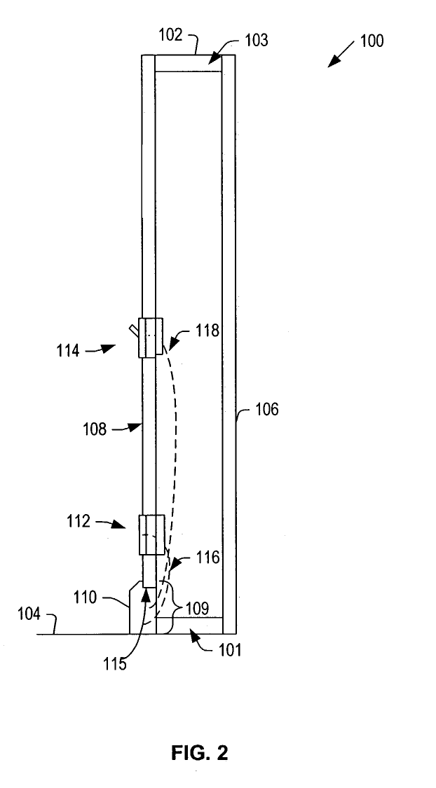

One embodiment is shown in FIG. 2. FIG. 2 shows the wall structure 100 in accordance with one embodiment of the present invention. Wall structure 100 comprises frame 102, which is constructed in accordance with conventional construction techniques, except that it may be somewhat higher than conventional frames. Generally frame 102 will include a horizontal baseplate 101, upon which are mounted vertical studs (not shown) positioned approximately 16″ apart. Upon these vertical studs is mounted a horizontal top plate 103. Frame 102 is mounted to floor 104. Also in accordance with conventional methods, outer wall 106 is mounted to frame 102.

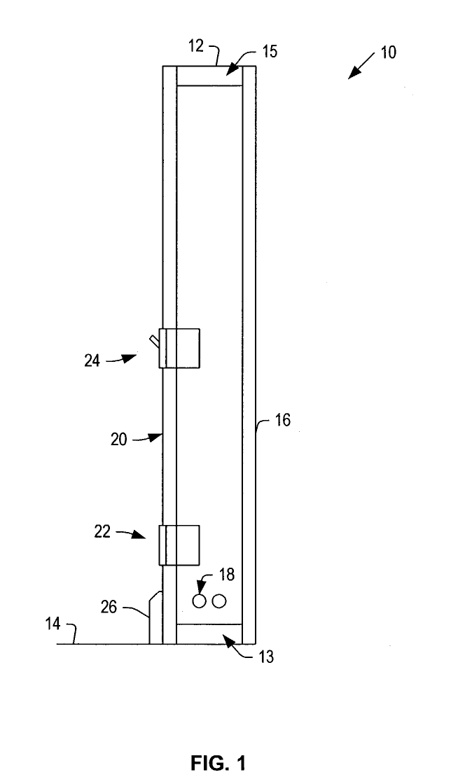

Outlets 112 and switches 114 are mounted to frame 102. Then modular electrical conduit 110 is installed at the base of frame 102. Then drywall 108 is mounted to frame 102 over modular electrical conduit 110. In accordance with one embodiment, modular electrical conduit 110 serves as a structural support for drywall 108. Modular electrical conduit 110 replaces baseboard 26 (FIG. 1). Unlike conventional wall structures, this modular conduit 110 occupies a gap 109 between the floor 104 and the bottom edge of the drywall 108. Thus conduit 110 can generally be between 3 and 6 inches in height, and in some embodiments, supports the bottom edge of drywall 108. In certain embodiments, conduit 110 has a groove 115 on its surface that supports the bottom edge of drywall 108. The bottom edge of drywall 108 fits into groove 115 and the bottom edge may be glued into groove 115.

Modular electrical conduit 110 is designed to contain all electrical and fiber optic lines required for a building. Wiring 116 can comprise 110-volt ac wires run to outlets 112, and switches 114. Wiring 116 to outlets 112, and switches 114 may also be comprise coaxial cable for analog or digital cable television, or various other wiring such as stereo speaker lines, conventional telephone lines, fiber optic cable, computer network lines, etc. In a preferred embodiment modular electrical conduit 110 has a depth equivalent to the thickness of the baseboard 26 (FIG. 1) and the inner wall surface 108, thus acting as a baseboard as well as a conduit. Since a typical baseboard 26 (FIG. 1) is ¾″ thick and typical drywall is ⅝″ thick, conduit 110 will typically be approximately 1.25″ deep, thereby appearing as a normal baseboard.

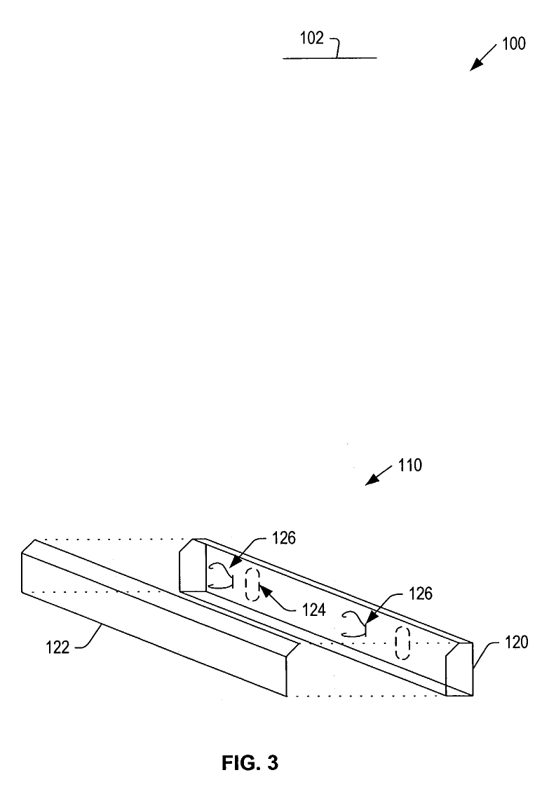

In accordance with an alternative embodiment, the depth of conduit 110 will extend partially into the volume of frame structure 102. Since the volume of frame 102 comprises mostly space between studs, such a conduit could have a back portion which extends into this frame volume. The structure of modular electrical conduit 110 is discussed in more detail with reference to FIG. 3 below.

In accordance with one embodiment, frame structure 102 has a height of 8 feet plus the span of gap 109. This allows the use of standard 8-foot lengths of drywall sheeting.

In accordance with other alternative embodiments, conduit 110 could be mounted to the frame 102 at the top plate 103 and the ceiling (not shown). In such a case, conduit 110 may have a groove on the surface that comes into contact with the top edge of the drywall. The groove serves to receive the top edge of the drywall so that conduit 110 can be attached to the drywall. The edge of the dry wall that comes into contact with conduit 110 may be glued into the groove. Alternatively, conduit 110 could run vertically up the wall structure 100 between separate sheets of drywall (not shown). In such a case, 110 may have a groove on each surface that comes into contact with the vertical edge of each sheet of drywall on either side of conduit 110. The vertical edge of the dry wall that comes into contact with conduit 110 may be glued into the groove.

FIG. 3 shows one embodiment of the modular conduit system 110 of the present invention. The conduit system 110 of FIG. 3 includes housing 120 and removable cover 122. Housing 120 is configured to be attached either to floor 104 (FIG. 2), or to the frame 102 (FIG. 2). Punch-outs 124 are perforated sections for allowing wires 116 (FIG. 2) and other communication lines to be routed up into the wall section 100 (FIG. 2). Housing 120 should generally be constructed of a conductive material such as aluminum or steel in order to minimize the effects of electromagnetism caused by any currents carried by ac power lines, or other wiring carried within housing 120. Also, housing 120 should generally be grounded for safety reasons.

Removable cover 122 is configured to be mounted to housing 120 such that cover 122 can be removed with ease in order to access the wiring contained within housing 120. Removable cover 122 can be constructed of any suitable material, but conductive materials are preferred in order to reduce electromagnetic effects. In accordance with one embodiment, cover 122 includes a decorative wood veneer configured to appear like a baseboard 26 (FIG. 1).

Cover 122 may be composed of a wide variety of materials, but must be mounted to housing 120 in a removable manner. In accordance with one embodiment, cover 122 is mounted with screws to housing 120. In accordance with an alternative embodiment, cover 122 includes male plastic snap fittings (not shown) configured to removably connect to female snap fittings (not shown) in housing 120. In accordance with yet another embodiment, housing 120 and cover 122 are connected via one or more hinges such that cover 122 may be flipped up in order to access the inside of housing 120. The above methods for connecting housing 120 and cover 122 are only examples. Those skilled in the fabrication of housings and their covers would have knowledge of such removable connectivity and could utilize many more methods not discussed herein, but which would be apparent as within the scope of the present invention.

In accordance with one embodiment, conduit 110 is manufactured in various standard sizes and lengths, such that one standard size is chosen for a particular residence, and the standard lengths most suitable for the interior dimensions of various rooms of the residence are used as needed. In accordance with one embodiment, conduits including elbow sections (not shown) of 90 degrees and various other angles are also available. Such elbow sections being configured to occupy corners in which wall sections 100 (FIG. 2) intersect.

In accordance with one embodiment, cutting standard length conduits to an appropriate length may create conduits of variable length. Methods for cleanly cutting complex structures such as conduits are not dealt with in this application, but such methods should be apparent to those skilled in the art.

In accordance with one embodiment, flexible ties 126 are imbedded in housing 120 for securing wiring or cables. Such flexible ties could be plastic or wire (such as those used for the bundling of electrical wire), or Velcro. Each would be spaced at some regular interval along the length of housing 120. In accordance with one embodiment ties would be positioned at various heights in order to enable different groups of wires and cables to be secured separately from other groups of wires to prevent electromagnetic signal interference between groups. In accordance with an exemplary embodiment, ties 126 are spaced along housing 120 at intervals of 6 inches.

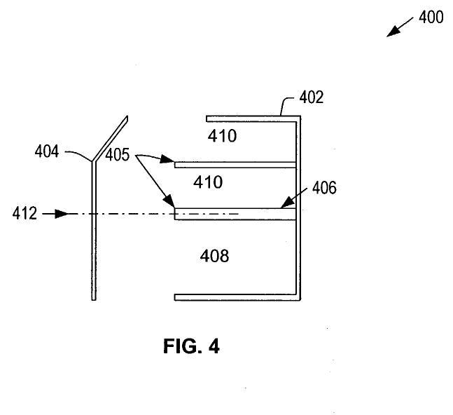

FIG. 4 is a cross-sectional end view of a conduit at 400 in accordance with one embodiment of the present invention. Conduit 400 includes housing 402 and cover 404. Housing 402 includes multiple shelf like dividers 405. Main divider 406 is a conductive shelf designed to separate high voltage (110 volts and above) power lines from more sensitive communications lines. In accordance with one embodiment, all high voltage power lines are contained in the lower compartment 408 below divider 406, while all lines containing low voltages such as telephone, computer network and cable television cables are contained in the upper compartments 410 above divider 406. Alternatively, high voltage lines may be contained in the upper compartment 410, and low voltage communications lines are housed in lower compartment 408.

This compartmentalization of housing 402 shields sensitive electrical lines within upper compartments 410 from the EMF (electric and magnetic fields) produced by high voltage lines running along lower compartment 408. In order for this shielding to be most effective, both shelf divider 406 and cover 404 should include some conductive material. However, shelf divider 406 and cover 404 need not mainly comprise conductive material. Such conductive material may be painted or coated in order to protect the material from wear and corrosion, and to prevent shorting of electrical wiring within conduit 400. In accordance with one embodiment, divider 406 and cover 404 include a wire mesh within a plastic body. In accordance with an alternative embodiment, the inner surfaces of housing 402 and cover 404 may be coated with a conductive material, painted with conductive paint, or electroplated.

In accordance with one embodiment, mounting screws (not shown) secure cover 404 to housing 402 via main divider 406 along axis 412. In accordance with such an embodiment, main divider 406 would be drilled and tapped at regular intervals suitable for accepting such screws, and cover 404 would include mounting holes corresponding with the tapped holes (not shown) in main divider 406. Alternatively cover 404 may include any suitable releasable male connectors, wherein main divider 406 includes corresponding female connectors. Any other method of removably mounting cover 404 to housing 402 may also be used.

In accordance with one embodiment, dividers 405 are removable and adjustable such that compartments 408, 410 may be added or shifted to accommodate different wiring arrangements. Such dividers could be attached to housing 402 via snaps, screws strip adhesive, Velcro, etc. In accordance with one embodiment, the back wall of housing 402 includes multiple slots (not shown) which accept dividers 408, 410, allowing a variable number of divider shelves 40 to be secured to housing 402 at variable heights. This architecture allows variation in the size and number of compartments 408, 410.

In accordance with one embodiment, flexible ties (not shown) are imbedded in housing 402 for securing wiring or cables. Such flexible ties could be plastic or wire (such as those used for the bundling of electrical wire), or Velcro. Each compartment 410, 410, 408 would include flexible ties spaced at some regular interval along the length of housing 402. In accordance with an exemplary embodiment, ties are spaced along housing 402 at intervals of 6 inches.

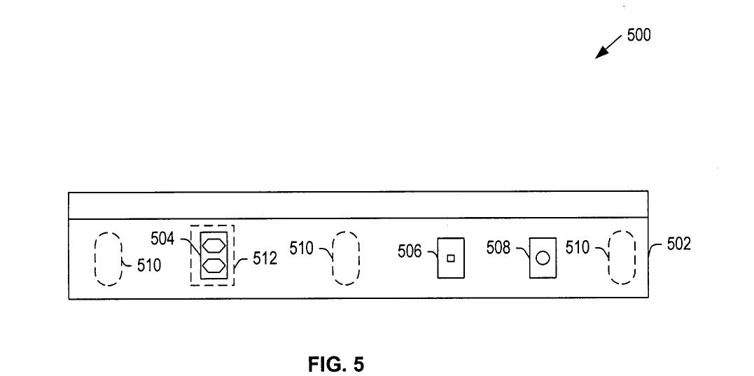

FIG. 5 is a front view of a conduit 500 in accordance with one embodiment of the present invention. Conduit 500 includes a cover 502 in which various outlets corresponding to various communications links and power links are mounted. Power outlet 504 provides 110-volt ac current to a typical home or business. Phone outlet 506 provides one or more telephone communication lines, while cable television outlet 508 provides digital or analog television signals to a home or business in accordance with the present invention. Punch-outs 510 located in the backside of the housing (not shown) provide a portal for wiring to enter the inside of wall section 100 (FIG. 2). Alternatively, punch out 512 is positioned directly behind one of the outlets 504, 506, 508 to provide additional clearance for the hardware required for the outlet. In accordance with such an embodiment, punch out opening 512 would have to be large enough to allow hardware required to wire each outlet to corresponding lines to protrude into the space contained between the vertical studs within framing 102 (FIG. 2).

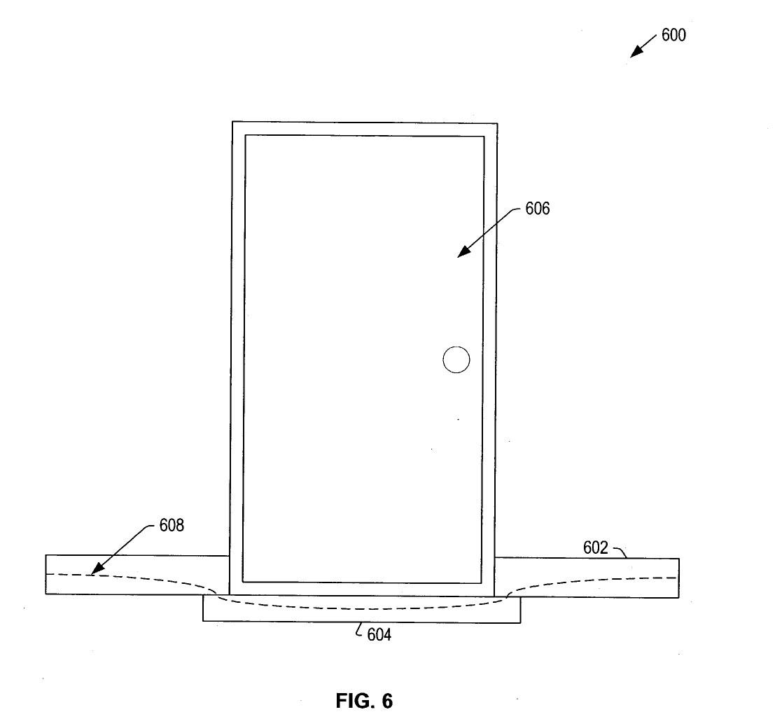

FIG. 6 is a front view of a conduit in accordance with one embodiment of the present invention. Conduit 602 includes sub-floor conduit section 604 imbedded within floor 104 (FIG. 2) beneath door 606. Sub-floor conduit section 604 includes a removable access plate (not shown) which also serves as a door sill. This architecture allows wiring and communications links to pass beneath a door 606, while still being accessible for future maintenance and upgrades. A dashed line 608 illustrates a typical path for wiring to travel in order to bypass door 606. In order to allow wiring 608 to travel between main conduit 602 and sub-floor conduit section 604, both sections 602 and 604 must overlap and have corresponding openings to allow wiring to be run though each.

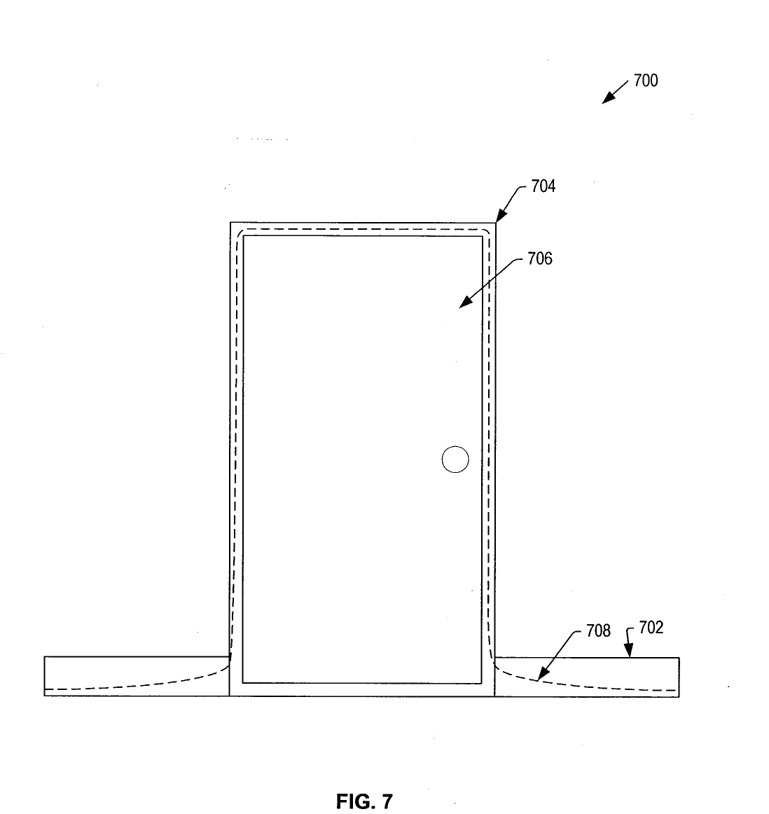

FIG. 7 is a front view of a conduit in accordance with one embodiment of the present invention. Conduit 702 includes door frame conduit section 704 positioned to support door 606. Door frame conduit section 704 includes a plurality of removable access plates (not shown) within the door jamb, which are concealed when door 706 is closed. This architecture allows wiring and communications links to pass around a door 706, while still being accessible for future maintenance and upgrades. A dashed line 708 illustrates a typical path for wiring to travel in order to bypass door 706.

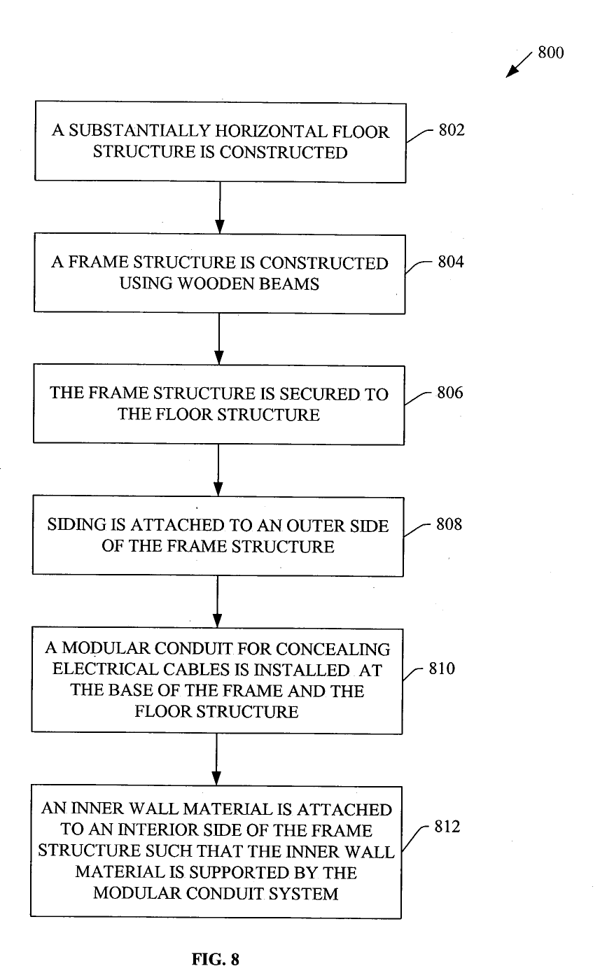

FIG. 8 is a method at 800 for constructing a wall in accordance with one embodiment of the present invention. The process begins at a step 802 in which a substantially horizontal floor structure is constructed. Such structures are commonly used throughout the construction industry. Then in a step 804 a frame structure is constructed using wooden beams. Generally, such frame structures include vertical studs attached to horizontal planks 101, 103 (FIG. 2) at the base and top of the frame structure. Generally such frames include a plurality of open areas between each vertical stud. Generally studs are positioned roughly 16″ apart. Then in step 806 the frame structure is secured to the floor structure, usually by means of nails or screws.

Then in step 808 siding is attached to an outer side of the frame structure. Common sidings include aluminum, steel and vinyl siding. Then in a step 810 a modular conduit for concealing electrical cables is installed at the base of the frame structure and the floor structure. This modular conduit includes a cover, which may be opened in order to access these concealed electrical cables. This cover is attached to the conduit by means of screws. In order to create the appearance of a traditional baseboard, the cover will include a wood grain veneer, and screws used to secure the cover will have wood grain caps or some other concealment.

Then in a step 812 an inner wall material is attached to an interior side of the frame structure such that the modular conduit structure supports the bottom edge of the inner wall material. The most common inner wall materials include plaster board and paneling. Such materials are generally attached with nails or screws to the studs of the frame structure. The frame structure will generally have to be slightly taller than conventional frame structures to accommodate the standard size of pre-cut drywall sheets, which are 8 feet in length.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A modular conduit system for routing electrical wiring and communications cables within an interior of a structure, said modular conduit system comprising,
a modular housing for containing said electrical wiring and said communications cables, wherein said modular housing is configured to be installed along an inner wall covering, wherein said modular housing includes one or more ports for enabling a plurality of outlets to be connected with said electrical wiring; and
a housing cover for enclosing said electrical wiring and said communications cables within said modular housing, wherein said housing cover:
is removably mounted with said modular housing; and
is configured to be removed in order to enable access to said electrical wiring and said communications cables without interfering with said inner wall covering.

2. The modular conduit system as recited in claim 1, wherein said modular housing is configured to be installed below a bottom edge of said inner wall covering.

3. The modular conduit system as recited in claim 1, wherein said modular housing is configured to be installed above a top edge of said inner wall covering.

4. The modular conduit system as recited in claim 1, wherein said modular housing is configured to be installed along a vertical edge of said inner wall covering.

5. The modular conduit system as recited in claim 1, wherein said modular housing includes a groove on one or more surfaces of said modular housing for receiving an edge of said inner wall covering.

6. The modular conduit system as recited in claim 1, wherein said inner wall covering includes a drywall layer.

7. The modular conduit system as recited in claim 1, wherein said one or more ports for enabling outlets to be connected with said electrical wiring include removable port covers, wherein said removable port covers, when removed, provide a path for electrical cables to be run to said outlets.

8. The modular conduit system as recited in claim 7, wherein said removable port covers comprise punch-out panels.

9. The modular conduit system as recited in claim 1, wherein said modular housing includes conductive material configured to reduce EMF (electrical and magnetic fields) within proximity with said modular conduit system.

10. The modular conduit system as recited in claim 1, wherein said modular housing includes a plurality of dividers for separating a plurality of cables in order to reduce electromagnetic interference between said plurality of cables, wherein said dividers are composed at least partially of conductive material.

11. The modular conduit system as recited in claim 10, wherein said dividers are configured to be mounted in various positions forming a configurable plurality of separated chambers for housing said electrical wiring and said communications cables.

12. The modular conduit system as recited in claim 10, wherein said dividers include a lip extending upward from an upper surface of each said divider, said lip being configured for retaining said electrical wiring and said communications cables upon said dividers.

13. The modular conduit system as recited in claim 1, wherein said housing cover is configured such that only a portion of said housing cover need be removed in order to access said electrical wiring and said communications cables, wherein at least one other portion of said housing cover remains connected with said modular housing during said access.

14. The modular conduit system as recited in claim 1, wherein said modular housing includes a back surface, wherein said back surface protrudes past an inner surface of said inner wall covering into a wall structure in order to provide additional space for said electrical wiring and said communications cables.

15. The modular conduit system as recited in claim 14, wherein said modular housing cover includes at least one outlet of said plurality of outlets, wherein said protruding back surface provides clearance for said at least one outlet.

16. The modular conduit system as recited in claim 1, wherein said electrical wiring includes at least one alternating current power line, and wherein said modular housing is connected with a ground.

17. The modular conduit system as recited in claim 1, wherein said communications cables includes at least one digital communications cable, and wherein at least one outlet of said plurality of outlets is a digital communications port.

18. The modular conduit system as recited in claim 1, further comprising:
a bypass housing for allowing said electrical wiring to bypass a door way; and
wherein said bypass housing is configured to mate to said modular housing in order to allow said electrical wiring and said communications cables to pass through said bypass housing and said modular housing.

19. The modular conduit system as recited in claim 18, wherein said bypass housing is configured to appear as part of said door way.

20. The modular conduit system as recited in claim 18, wherein said bypass housing is configured for installing in a sub-floor beneath said door way.

21. A modular conduit system for installation along an inner wall having a predetermined wall thickness and for providing an enclosure for electrical lines carrying various signals, said conduit system comprising:
a modular conduit housing configured to retain a plurality of signal carrying cables, wherein said modular conduit housing is further configured to function as a baseboard positioned beneath a substantially horizontal bottom edge of said inner wall such that said predetermined wall thickness can be utilized for containing said plurality of signal carrying cables, and
a conduit cover configured to enclose said plurality of signal carrying cables within said modular conduit housing such that said signal carrying cables are accessible without altering said inner wall.

22. The modular conduit system as recited in claim 21, wherein said conduit cover is at least partially detachable from said modular conduit housing, and wherein said conduit cover appears as a contemporary baseboard on a room's interior, wherein said conduit cover may be opened from within said room without damage to said room.

23. A conduit for concealing a plurality of transmission cables within a wall structure, the conduit comprising:
an elongated enclosure for retaining said transmission cables and providing portals to an enclosed space within said wall structure, said portals enabling said transmission cables to be coupled with outlets installed in said wall structure; and
an elongated cover for concealing said transmission cables within said elongated enclosure and providing access to said transmission cables within said elongated enclosure, wherein said elongated cover is removably secured to said elongated enclosure such that, when secured, said elongated cover and said elongated enclosure function to form a portion of said wall structure.

24. The conduit of claim 23, wherein said elongated enclosure is configured to be attached to additional elongated enclosures in order to form a substantially continuous conduit structure, wherein an exposed portion of said conduit structure appears to be a wall-trim, and wherein said conduit structure includes conductive material configured to reduce electromagnetic field effects in proximity with said conduit structure, wherein said conduit structure is grounded to protect electrical systems connected with said transmission cables.

25. The conduit of claim 24, wherein said elongated enclosure includes sub-enclosures configured to separate said plurality of transmission cables from one another, and to electromagnetically shield said transmission cables from one another.

26. An apparatus for routing a plurality of transmission cables within a habitable structure comprising:
an elongated enclosure having side walls for enclosing at least a portion of said transmission cables;
said elongated enclosure having a first side wall removably connected with said elongated enclosure such that said first side wall can be manipulated to enable access to said transmission cables from within said habitable structure;
said elongated enclosure having a second side wall configured to border an edge of an inner wall covering;
said elongated enclosure having a third side wall configured to border a wall frame structure, wherein said wall frame structure includes an enclosed space, wherein said third side wall includes at least one opening for enabling said transmission cables to be communicatively connected to wall outlets via said enclosed space, wherein said wall outlets are integral with said inner wall covering; and
wherein said elongated enclosure and said inner wall covering act in unison to enclose said enclosed space of said wall structure, thereby maximizing a volume of said elongated enclosure while minimizing one or more dimensions of said elongated enclosure.

27. A method for accessing an internal wiring of a habitable structure comprising:
opening an access cover attached to a housing in order to access transmission cables contained within said housing, wherein said access cover is configured to act as a baseboard, and wherein said housing is configured to provide space for said transmission cables within a wall structure,
adding additional transmission cables to provide upgraded communications capabilities to said habitable structure without damaging said wall structure; and
concealing said additional transmission cables by closing said access cover.

28. A method for constructing a wall structure comprising the acts of:
providing a substantially horizontal floor structure;
providing a frame structure including beams and open spaces between said beams;
attaching said frame structure to said floor structure;
providing an outer wall siding;
attaching said outer wall siding to an outer side of said frame structure;
providing a modular conduit for concealing electrical cables, wherein said modular conduit may be opened in order to access said concealed electrical cables;
and wherein said modular conduit has a back surface;
attaching said modular conduit to said frame structure such that said back surface of said modular conduit abuts a portion of said frame structure;
providing an inner wall material such as plaster board; and
attaching said inner wall material to an inner side of said frame structure such that said modular conduit separates said inner wall material from said floor structure.
